(19) United States
(12) Patent Application Publication
(10) Pub. No.: US 2007/0133029 A1
(43) Pub. Date: Jun. 14, 2007

(54) METHOD OF RECOGNIZING TEXT INFORMATION FROM A VECTOR/RASTER IMAGE

(76) Inventors: Dmitri Deriaguine, Moscow (RU); Vyacheslav Sapronenko, Moscow (RU)

Correspondence Address: ABBYY Software Ltd.;Attn. Sergey Platonov, 11-1, KASATKINA STR., P.O. Box #54, Moscow, 129301, RU

(21) Appl. No.: 11/428,845

(22) Filed: Jul. 6, 2006

(30) Foreign Application Priority Data
Dec. 8, 2005 (RU) 2005138164 A1

(51) Int. Cl. G06F 3/12

(52) U.S. Cl. 358/1.13; 358/462

(57) ABSTRACT

A method is claimed for preprocessing a vector-raster image file which contains a text image. The method comprises the steps of: fragmenting the image to obtain regions containing non-separable, logically connected fragments of text of the maximum possible size; processing text, vector, and raster objects; discarding excessive information; analyzing each object with the help of all available information. The step of processing text objects includes the steps of: dividing into separate characters and character groups according to supposed locations of blank spaces or other non-indicated symbols, and analyzing and assembling character groups into words. The step of processing vector objects includes the step of identifying separators, background, and substrates of blocks. The step of processing raster objects includes the steps of: analyzing non-text objects on order to detect text images within them, and/or detecting vector objects other than separators.

### FIELD OF THE INVENTION

The proposed technical solution relates to pattern recognition and particularly to preprocessing of a document in electronic form which is performed prior to operations of text recognition (or instead of recognition).

The proposed technical solution allows extracting information about the content and formatting from a vector/raster image of a document, for example, from a file in PDF format, which is sufficient to restore the document later in the original or close to original form in any known editable format.

### BACKGROUND OF THE INVENTION

A method of extracting information text information from an electronic image file in vector/raster format is known in the art. This method is used by the company-manufacturer of tools for obtaining documents in vector-raster format (PDF format). “Acrobat and PDF Library API Reference”, Jan. 7, 2005, Adobe Solutions Network, 3603p.

The disadvantage of this method is its ability to extract only text information, without retaining information about the formatting of the document.

The above method is taken as a prototype.

The technical result consists in broadening the capabilities of recognizing a document from an electronic image file in vector-raster format, increasing the reliability of obtaining text, raster, and vector objects, extracting the information about the formatting of the document, and accelerating the processing.

The known method does not allow achieving the described technical result.

### SUMMARY OF THE INVENTION

The announced technical result is achieved by means of performing the following sequence of steps: fragmenting the image in order to obtain regions containing non-separable, logically connected fragments of text of the maximum possible size; processing text objects; processing vector objects; processing raster objects; discarding redundant and excessive information; processing objects other than text, raster, or vector objects using the methods of raster objects processing; analyzing each object with the help of all available information that has been obtained as a result of the processing of other objects.

Acceleration of the processing is achieved, among other things, by excluding or reducing some commonly performed operations.

For example, in many cases, the necessity to recognize a raster text is partially or completely discarded.

### DETAILED DESCRIPTION OF THE INVENTION

The essence of the method of preprocessing text information on the basis of the information about a vector-raster image in electronic form consists in the following.

During the preprocessing (prior to character recognition), the following operations are performed using the attributes of the file formatting which are available in the vector-raster image file.
The image is fragmented in order to obtain regions containing non-separable, logically connected fragments of text of the maximum possible size. To do this, the program divides the image into regions that presumably contain text fragments, and then analyzes adjacent regions for the purpose of uniting them into greater regions.
Text objects are processed. Processing of text object includes at least steps of: dividing into separate characters and character groups according to supposed locations of blank spaces or other non-indicated symbols; analyzing and assembling (uniting, collecting) character groups into lines. The step of dividing into separate characters and character groups includes at least the step of converting the absolute coordinates of characters into groups which are separated by blank spaces and enlarged inter-character intervals.

The step of analyzing and uniting (assembling) character groups into lines includes at least the following steps:

a) determining the text orientation;

b) detecting text written as a superscript;

c) detecting text written as a subscript;

d) detecting text of dropped capitals.

After assembling, a row is divided into words on the basis of the location of blank spaces, if any, and the analysis of inter-character intervals where there are no blank spaces.

Vector objects are processed. Processing of vector objects includes at least the step of identifying separators, background, and substrates of blocks.

Raster objects are processed. Processing of raster objects includes at least the steps of: analyzing non-text objects in order to detect text images within them, detecting vector objects other than separators including those partially located outside the borders of the object.

Redundant and excessive information is discarded. Discarded redundant and excessive information includes at least the information about the shading of characters, about unnecessary attributes, and some other information depending on the peculiarities of the document.

The program processes objects other than text, raster, or vector objects using the methods of raster objects processing.

Each object is additionally analyzed with the help of all available information that has been obtained as a result of the processing of other objects. If, according to the results of the primary processing of an object, the program has obtained some information which can affect other objects, repeated analysis of these other objects is performed.

After dividing an object into rows and words, the program analyzes the correctness of the encoding of characters, and corrects it, if necessary. In order to determine the correctness of the encoding, the text is analyzed and the following are checked: the correspondence of the letters of the text to the alphabet of the given language, and the correspondence of the words of the text to the dictionary of the given language.

If the program has failed to extract the text with the help of other known methods, the text block is sent to recognition.

1. A method for preprocessing a vector/raster image file which contains a text image, text and/or raster and/or vector objects; said method comprises the following steps performed using the attributes of the file formatting:
fragmenting the image in order to obtain regions presumably containing paragraphs, tables, text lines, text symbols, and non-text objects;
processing text objects;
processing raster objects;
processing vector objects;
discarding redundant and excessive information;
processing objects other than text, raster, or vector objects using the methods of raster objects processing;
analyzing each object with the help of all available information that has been obtained as a result of the processing of other objects;
said step of fragmenting the image is performed until the program obtains regions containing non-separable, logically connected fragments of text of the maximum possible size;
said step of obtaining non-separable, logically connected fragments of text of the maximum possible size includes at least the following steps of:
dividing the image into regions that supposedly contain text fragments;
analyzing adjacent regions for the purpose of uniting them into greater regions;
said step of processing said text objects includes at least the following steps of:
dividing thereof into separate characters and character groups according to supposed locations of blank spaces and/or other non-indicated symbols;
analyzing character groups and assembling them into words; said step of processing said vector objects includes at least the step of identifying separators, background, and substrates of blocks;
said step of processing said raster objects includes at least the following steps of:
analyzing non-text objects in order to detect text images within them;
detecting vector objects other than separators including those partially located outside the borders of the object.

2. The method as recited in claim 1, further comprising the step of analyzing the correctness of the encoding of characters, and correcting it, if necessary.

3. The method as recited in claim 2, further comprising the step of analyzing the text and checking:
the correspondence of the letters of the text to the alphabet of the given language, and
the correspondence of the words of the text to the dictionary of the given language.

4. The method as recited in claim 2, wherein, in the case of failing to obtain a sufficiently reliable result with the help of other known methods, the text block is sent to recognition.

5. The method as recited in claim 1, wherein discarded redundant and excessive information includes at least the following types:
a) the information about the shading of characters;
b) superfluous attributes.

6. The method as recited in claim 1, wherein the step of dividing into separate characters and character groups includes at least the step of converting the sets of absolute coordinates of neighboring characters into groups divided by revealed blank spaces.

7. The method as recited in claim 1, wherein the step of analyzing and assembling character groups into words includes at least the following steps of:
converting the absolute coordinates of characters into
groups divided by revealed blank spaces;
determining the orientation of the text;
detecting text written as a superscript;
detecting text written as a subscript;
detecting text of dropped capitals.
